(19) United States
(12) Patent Application Publication
(10) Pub. No.: US 2017/0194844 A1
(43) Pub. Date: Jul. 6, 2017

(54) DC MOTOR STRUCTURE WITH HOLLOW ROTOR AND INNER AND OUTER STATORS

(71) Applicant: XINGU MOTOR INC., Taipei City (TW)

(72) Inventor: Lien-Hsin WU, Taipei City (TW)

(21) Appl. No.: 15/066,301

(22) Filed: Mar. 10, 2016

(30) Foreign Application Priority Data
Dec. 31, 2015 (TW) 104144664

(51) Int. Cl. H02K 16/04; H02K 23/36; H02K 13/00; H02K 3/28; H02K 3/12

(52) U.S. Cl. CPC H02K 16/04; H02K 3/28; H02K 3/12; H02K 13/006; H02K 23/36

(57) ABSTRACT

The present invention provides a DC motor structure with a hollow rotor and inner and outer stators includes a housing, a commutator, and an output element, in addition to the hollow rotor and the stators. The commutator and the output element are received at the front and rear ends of the housing respectively. The outer stator, the hollow rotor, and the inner stator are sequentially arranged in the housing in a direction toward the central axis of the housing. The hollow rotor between the stators is wound with plural windings and has a front end and a rear end respectively connected to the commutator and the output element. When each winding receives a current from the commutator, the hollow rotor generates a corresponding electromagnetic field such that the commutator and the output element rotate simultaneously with the hollow rotor to output directly through the output element the rotating force generated by the hollow rotor.

### BACKGROUND OF THE INVENTION

1. Technical Field

The present invention relates to direct-current motors and more particularly to a direct-current motor structure having a hollow rotor and a stator inside as well as outside the hollow rotor.

2. Description of Related Art

An electric motor, or generally referred to as a motor, serves mainly to convert the electricity received into mechanical energy and produce kinetic energy from the mechanical energy in order to drive another device. Hence, motors have been extensively used in a variety of products such as electric vehicles, lathes, electric fans, and water pumps. Direct-current (DC) motors are the first devices capable of converting electricity into mechanical energy, followed by induction motors and synchronous motors, both of which emerged due to the prevalence of alternating-current (AC) electric power and have since lowered the importance and reduced the applications of DC motors. However, with the advent of silicon controlled rectifiers (SCRs) and the improvement of magnetic materials, carbon brushes, and insulating materials, plus the increasing demand for variable-speed control, DC motors have once again become a crucial technology in industrial automation. This is mainly because both the “rotation speed vs. torque” and “current vs. torque” characteristic curves of DC motors are linear, which renders DC motors simple and easy to control. DC motors, therefore, remain the most common motors for variable-speed control.

Referring to FIG. 1A, the structure of a conventional DC motor 1 essentially includes a housing 10, a pivot shaft 11, a rotor 12, a stator 13, and a commutator 14. The housing 10 is provided therein with a receiving space 101. The pivot shaft 11 is pivotally provided in the housing 10 and has one end formed as an output shaft 111. The output shaft 11 juts out of the housing 10. The rotor 12 is assembled from a plurality of silicon steel plates, is fixedly mounted around the pivot shaft 11, and is wound with a plurality of windings. The stator 13 is composed of permanent magnets, is fixedly provided on the inner wall of the housing 10, corresponds to the outer periphery of the rotor 12, and is spaced from the rotor 12. The commutator 14 is provided in the receiving space 101, is configured to receive external electricity, and is electrically connected to the windings in order to supply electricity to the windings. The commutator 14 can also change the direction of the current supplied to the windings. According to Fleming's left-hand rule or right-hand palm rule, a conductive wire placed in a magnetic field and supplied with a current generates a magnetic field which cuts through the existing magnetic field lines such that the conductive wire is moved. When the windings on the rotor 12 are supplied with electricity, therefore, the magnetic fields generated by the windings cut through the lines of magnetic force generated by the stator 13, producing a torque that rotates the rotor 12 and thereby converts electrical energy into kinetic energy. For example, referring to FIG. 1B, where the lines of magnetic force of the stator 13 are from left to right, a current flowing into the windings of the rotor 12 from the right and exiting to the left causes the rotor 12 to generate a torque that forces the rotor 12 into clockwise rotation.

Generally, referring back to FIG. 1A, the kinetic energy generated by the rotor 12 is output through the output shaft 111 at one end of the pivot shaft 11, so it is typically required that a transmission mechanism (e.g., a gear) be mounted to the output shaft 111 at one end of the pivot shaft 11. This transmission mechanism, however, leads to a complicated structure when the DC motor 1 is put to use. Moreover, the output shaft 111, which juts out of the housing 10 as a free end, often has a small length to prevent the axis of the output shaft 111 from shifting, but given the typical high rotation speed of the pivot shaft 11 needed to generate a rotating force large enough to drive the transmission mechanism, the components of the transmission mechanism are subject to wear and tear caused by long-term excessive loading and may hence render uneven the force acting on the output shaft 111, thus shifting the axis of the output shaft 111 anyway.

According to the above, the overall structure of the existing DC motors still leaves room for improvement in practical use. It is therefore an important issue for DC motor manufacturers and designers to develop a novel DC motor structure which can overcome the foregoing problems and generate a rotating force featuring a low rotation speed and a large torque to win users' favor.

### BRIEF SUMMARY OF THE INVENTION

In view of the imperfection of the conventional DC motor structure described above, the inventor of the present invention incorporated years of practical experience into extensive research and experiment and finally succeeded in developing a DC motor structure with a hollow rotor and inner and outer stators as disclosed herein. The present invention is intended to provide a DC motor which performs better than its prior art counterparts.

It is an objective of the present invention to provide a DC motor structure having a hollow rotor and inner and outer stators. The DC motor structure includes a housing, an outer stator, a commutator, an output element, a hollow rotor, and an inner stator. The housing is cylindrical and is provided therein with a receiving space. The rear end of the housing is formed with at least one output hole in communication with the receiving space. The commutator and the output element are received at the front and rear ends of the housing respectively. The outer stator, the hollow rotor, and the inner stator are sequentially arranged in the housing in a direction toward the central axis of the housing. The hollow rotor is wound with a plurality of windings. The front and rear ends of the hollow rotor are connected with the commutator and the output element respectively. The two ends of each winding are respectively and electrically connected to two adjacent commutator plates on the commutator in order to receive the current supplied by the commutator. Each two adjacent commutator plates on the commutator are configured to reverse the current direction in the corresponding winding at a preset frequency so that the electromagnetic field generated by the corresponding winding is simultaneously reversed too. The reversal of current direction is repeated again and again at the preset frequency in order for the hollow rotor to generate the corresponding electromagnetic fields. The outer stator includes a plurality of outer magnets which are fixed to the inner wall of the housing along the circumferential direction of the housing. Each two adjacent outer magnets are spaced apart and are opposite in polarity. The inner stator includes a plurality of inner magnets which are fixed to the outer periphery of the inner stator along the circumferential direction of the housing. Each two adjacent inner magnets are spaced apart and are opposite in polarity. Moreover, the inner magnets correspond to the outer magnets respectively. When the windings receive the currents supplied by the commutator and generate the corresponding electromagnetic fields, both the inner magnets of the inner stator and the outer magnets of the outer stator are repelled by the electromagnetic fields such that the hollow rotor is rotated and drives the output element simultaneously. Thus, by way of a transmission element (e.g., a chain or belt), the rotating force generated by the hollow rotor is output by the output element to a load (e.g., a gearbox) through the output hole, wherein the rotating force features a low rotation speed and a large torque. The power efficiency and service life of the DC motor structure are therefore improved in comparison with those of the conventional DC motors.

### BRIEF DESCRIPTION OF THE SEVERAL VIEWS OF THE DRAWINGS

The objects as well as the technical contents and features of the present invention will be best understood by referring to the following detailed description of a preferred embodiment in conjunction with the accompanying drawings, in which:

FIG. 1A schematically shows the structure of a conventional DC motor;

FIG. 1B schematically shows the working principle of a conventional DC motor;

FIG. 2 is an exploded view of the DC motor structure of the present invention;

FIG. 3 is a sectional view of the DC motor structure of the present invention;

FIG. 4 is a partial perspective view of the hollow rotor of the present invention; and

FIG. 5 schematically shows two windings on the hollow rotor of the present invention.

### DETAILED DESCRIPTION OF THE INVENTION

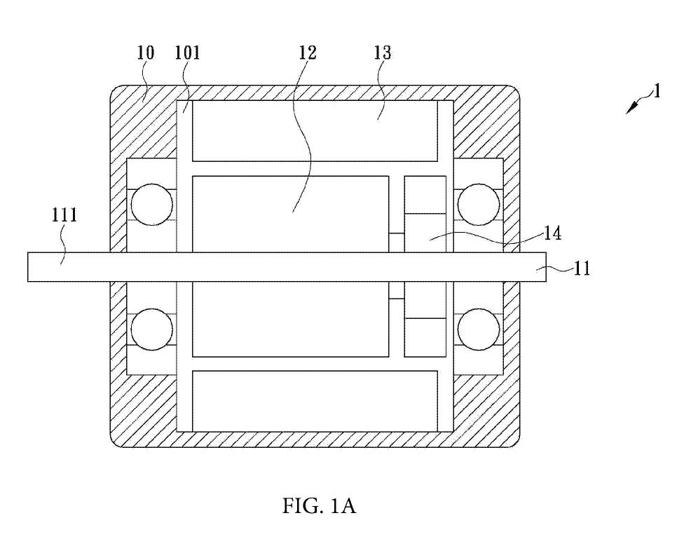

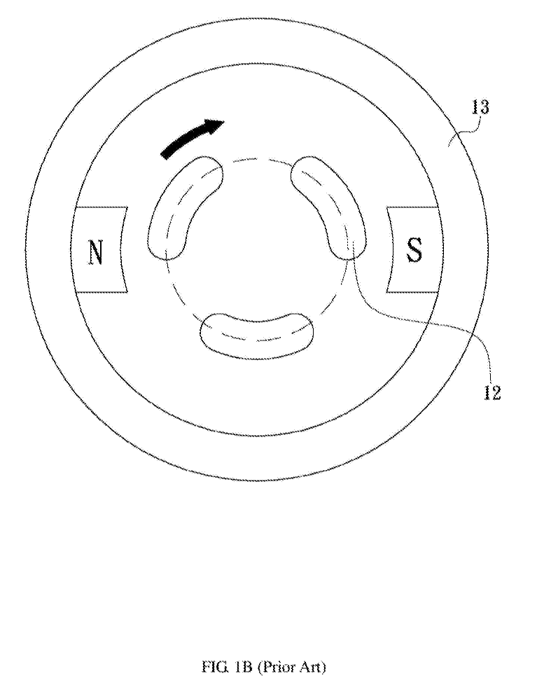

As stated above, the conventional DC motors output power via an output shaft, which, like the output shaft 111 in FIG. 1A, is part of a pivot shaft. Therefore, when the load of a conventional DC motor (e.g., the gearbox of an electric vehicle, or other large equipment) has to be driven by a great rotating force, the conventional DC motor must rotate at high speed to generate the required rotating force. And because of that, the conventional DC motor is subject to structural damage and consumes considerable electricity. In light of this, the inventor of the present invention specifically designed a novel DC motor structure which dispenses with the output shaft 111 in FIG. 1A and is capable of driving a transmission mechanism by generating a large torque at a low rotation speed. It should be pointed out that the DC motor structure with a hollow rotor and inner and outer stators of the present invention is not limited to that which is depicted in the accompanying drawings. A person skilled in the art who has fully grasped the technical features of the invention should be able to adjust the shapes and number of the components in the embodiments disclosed herein.

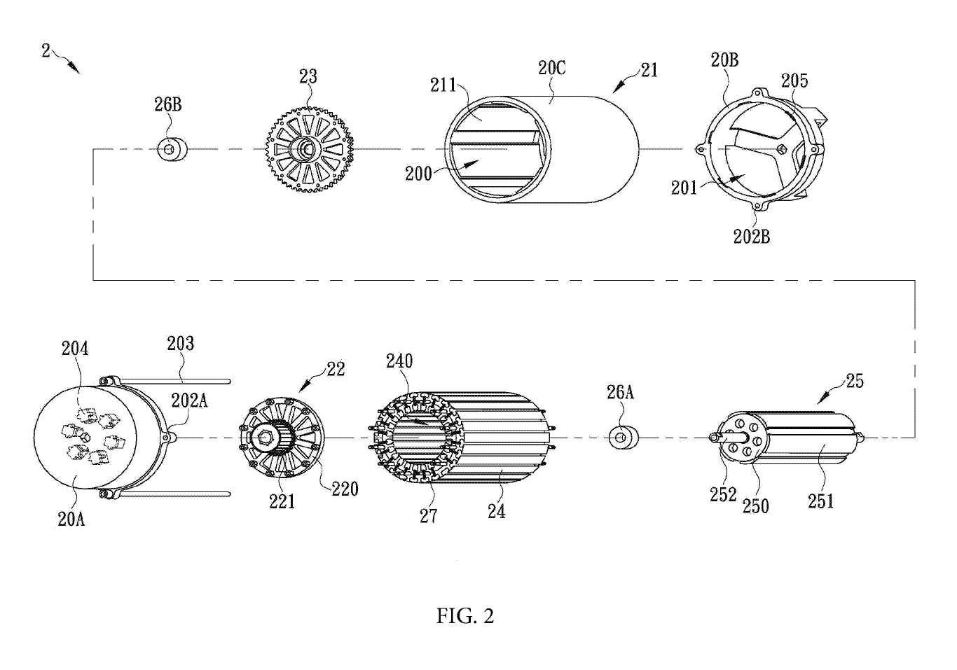

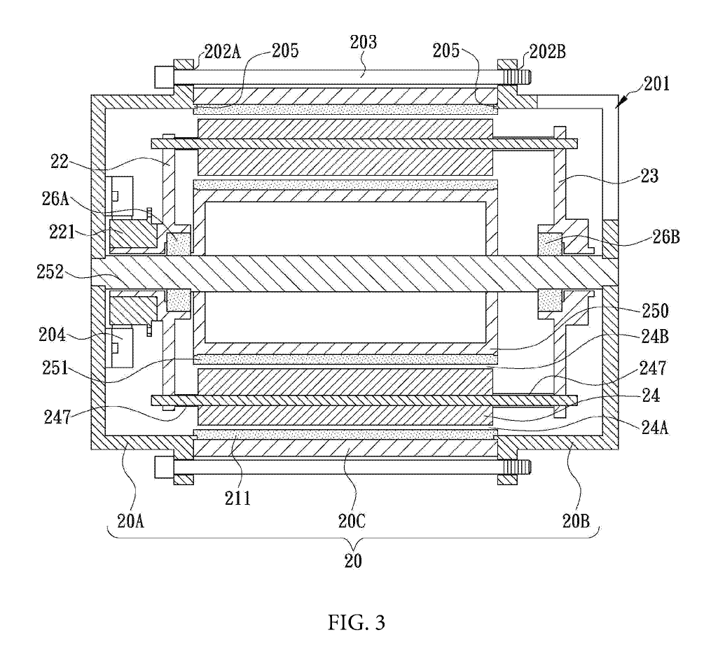

The present invention provides a DC motor structure having a hollow rotor and inner and outer stators. In a preferred embodiment of the invention, referring to FIG. 2 and FIG. 3 (with the leftward direction in FIG. 2 defined as the front direction of each component, and the rightward direction, the rear direction of each component), the DC motor structure 2 includes a housing 20, an outer stator 21, a commutator 22, an output element 23, a hollow rotor 24, and an inner stator 25. The housing 20 is cylindrical and is provided therein with a receiving space 200. The rear end of the housing 20 is formed with three output holes 201 in communication with the receiving space 200. In other embodiments of the present invention, however, there may be only one output hole 201, and the configuration of the at least one output hole 201 may vary according to practical needs. In the present invention, the term “output hole 201” refers to a space through which the output element 23 can connect with an external transmission mechanism, and all arrangements allowing the output element 23 to connect with an external transmission mechanism should be viewed as equivalent configurations. The present invention imposes no limitations on the configuration of the at least one output hole 201.

In this embodiment, the housing 20 is assembled from a front cover 20A, a rear cover 20B, and a housing body 20C. The front cover 20A is peripherally provided with a plurality of front connecting portions 202A (e.g., locking holes). A plurality of carbon brushes 204 are mounted in the front cover 20A and are configured to receive an external current. The rear cover 20B is provided with the output holes 201 and is peripherally provided with a plurality of rear connecting portions 202B (e.g., locking holes). The housing body 20C is tubular and is engaged between the front cover 20A and the rear cover 20B. Each corresponding pair of front connecting portion 202A and rear connecting portion 202B can be respectively and fixedly connected with the two ends of a connecting rod 203 to connect the front cover 20A, the rear cover 20B, and the housing body 20C together, thereby forming the housing 20 of the present invention. To prevent the housing body 20C from rotation, the front cover 20A and the rear cover 20B are each provided with a plurality of engaging portions 205 (e.g., protruding plates) for engaging with one of the two ends of the housing body 20C. In other embodiments of the present invention, however, the housing 20 may be designed as a single component or as a combination of at least two components (e.g., the front cover 20A and the rear cover 20B alone, or with more than one housing body 20C). The housing 20 is by no means limited to the assembly of the three components disclosed herein, i.e., the front cover 20A, the rear cover 20B, and the housing body 20C.

As shown in FIG. 2, the outer stator 21 is mounted in the receiving space 200 and includes a plurality of outer magnets 211. In this embodiment, the outer magnets 211 are located in the housing body 20C and are fixed to the inner wall of the housing body 20C along the circumferential direction of the housing body 20C (i.e., of the housing 20). Each two adjacent outer magnets 211 are spaced apart and are opposite in polarity. Each outer magnet 211 can be a single magnetic component or composed of a plurality of magnetic components of the same polar direction; the present invention has no limitations in this regard. In other embodiments of the present invention, the outer stator 21 may further include an outer stator body which is tubular and is fixed to the inner wall of the housing 20, with the outer magnets 211 fixed in the outer stator body. This allows the outer stator 21 to be manufactured independently or custom-made, adding to the convenience of production. It is worth mentioning that the outer stator body, if provided, resembles the housing body 20C in configuration, and that the outer stator body not only can be omitted as in this embodiment, but also can be integrated with the housing 20, in order to reduce the number of components of the DC motor structure 2.

Referring to FIG. 2 and FIG. 3, the commutator 22 is mounted in the receiving space 200 and is pivotally connected to the inner wall of the front end of the housing 20 along the axial direction of the housing 20. In this embodiment, the commutator 22 is located in the front cover 20A and is electrically connected to the carbon brushes 204 in the front cover 20A in order to receive an external current through the carbon brushes 204. The commutator 22 includes a disk 220 and a plurality of commutator plates 221. The commutator plates 221 are mounted on the front side of the disk 220, with a space between each two adjacent commutator plates 221. It should be pointed out that the electrical connection between the carbon brushes 204 and the commutator 22 of the present invention is well known in the art and therefore will not be detailed herein. The carbon brushes 204 and the commutator 22 can be connected in many different ways provided that they can deliver an electric current to each other. The output element 23 is mounted in the receiving space 200, is pivotally connected to the inner wall of the rear end of the housing 20 along the axial direction of the housing 20, and corresponds in position to the output holes 201. In this embodiment, the output element 23 is gear-shaped, is located in the rear cover 20B, and corresponds in position to the output holes 201. A transmission element (e.g., a chain) can be passed through the output holes 201 and connected with the output element 23, allowing the kinetic energy generated by the DC motor structure 2 during operation to be output to a load (e.g., a gearbox) sequentially through the output element 23 and the transmission element, in order for the kinetic energy to drive the load into operation. In other embodiments of the present invention, however, the output element 23 may be a hub or other components, and the transmission element may be a closed-loop belt or other components. That is to say, the output element 23 may vary in configuration, depending on the load and the form of the transmission element, so that the DC motor structure 2 of the present invention can be applied to a greater variety of equipment or devices.

With continued reference to FIG. 2 and FIG. 3, the hollow rotor 24 is mounted in the outer stator 21 along the axial direction of the housing 20 and is spaced from the outer stator 21 by a first spacing 24A to enable free rotation of the hollow rotor 24 within the outer stator 21. The hollow rotor 24 is assembled from a plurality of iron cores. An axial hole 240 is formed in the hollow rotor 24 and extends along the axial direction of the hollow rotor 24. The front end of the hollow rotor 24 is connected with the commutator 22 while the rear end of the hollow rotor 24 is connected with the output element 23. The hollow rotor 24 is wound with a plurality of windings 27. Each winding 27 has two ends respectively and electrically connected to two adjacent commutator plates 221 on the commutator 22 in order to receive a current from the commutator 22 and thereby cause the hollow rotor 24 to generate a corresponding electromagnetic field. Each two adjacent commutator plates 221 on the commutator 22 can reverse the current direction in the corresponding winding 27 at a preset frequency so that the electromagnetic field generated by the corresponding winding 27 is reversed at the same time. The reversal of current direction is repeated again and again at the preset frequency. When rotated under the action of magnetic fields, the hollow rotor 24 rotates the commutator 22 and the output element 23 simultaneously.

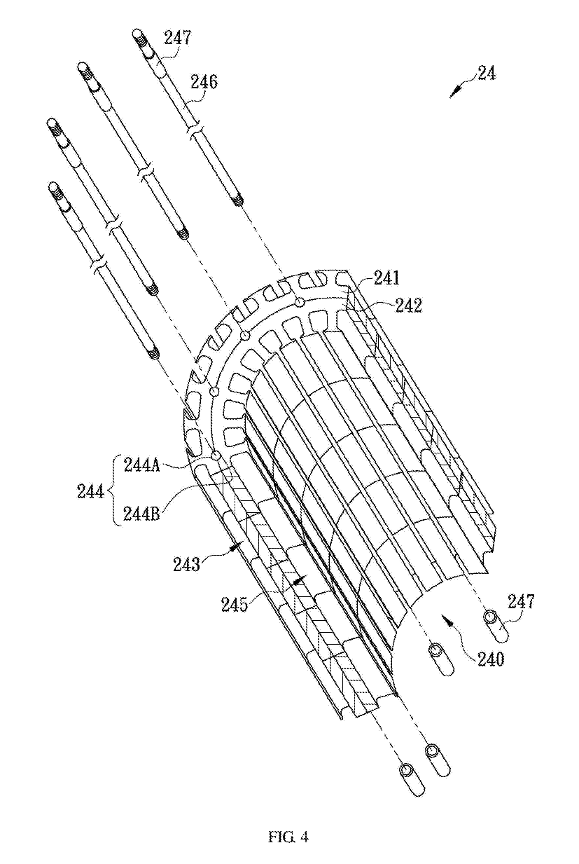

Reference is now made to FIG. 2 and FIG. 4 for a detailed description of the structure of the hollow rotor 24. The hollow rotor 24 includes an outer iron core 241 and an inner iron core 242. Each of the outer iron core 241 and the inner iron core 242 is assembled from a plurality of silicon steel plates. The outer surface of the outer iron core 241 is provided with a plurality of outer winding grooves 243 which extend along the axial direction of the outer iron core 241. The inner surface of the outer iron core 241 is provided with a plurality of first recesses 244A which also extend along the axial direction of the outer iron core 241. The inner surface of the inner iron core 242 is provided with a plurality of inner winding grooves 245 which extend along the axial direction of the inner iron core 242, and the outer surface of the inner iron core 242 is provided with a plurality of second recesses 244B which also extend along the axial direction of the inner iron core 242. The outer winding grooves 243 and the inner winding grooves 245 are configured to be wound with the windings 27. When the outer iron core 241 and the inner iron core 242 are put together, the inner surface of the outer iron core 241 lies against the outer surface of the inner iron core 242, with each first recess 244A corresponding to one second recess 244B to form a fixing hole 244. The fixing holes 244, therefore, are arranged along the circumferential direction of the hollow rotor 24. A plurality of fixing rods 246 are inserted into the fixing holes 244 respectively to connect with the hollow rotor 24. The front end of each fixing rod 246 is exposed from the hollow rotor 24 and is fixed to the rear side of the disk 220 of the commutator 22. The rear end of each fixing rod 246 is also exposed from the hollow rotor 24 and is fixed to the output element 23. As a result, the hollow rotor 24, the commutator 22, and the output element 23 are assembled together as a single unit for simultaneous rotation.

Referring again to FIG. 2 and FIG. 4, in order to prevent the commutator 22 and the output element 23 from contact with the windings 27 on the hollow rotor 24, the front and rear ends of each fixing rod 246 are each mounted with a position-limiting tube 247 whose outer diameter is greater than the diameter of the fixing holes 244 and which therefore cannot extend into any fixing hole 244 and is located either between the commutator 22 and the hollow rotor 24 or between the output element 23 and the hollow rotor 24 to keep the commutator 22 or the output element 23 from contact with the windings 27 on the hollow rotor 24. It should be pointed out that, in other embodiments of the present invention, the hollow rotor 24, the commutator 22, and the output element 23 may be connected in other ways, provided that the hollow rotor 24 is able to drive the commutator 22 and the output element 23 simultaneously and is spaced from each of the commutator 22 and the output element 23 by a predetermined spacing.

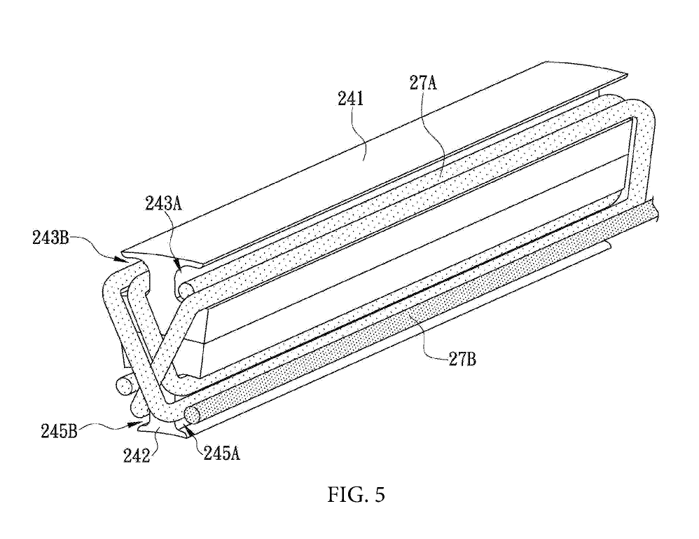

As shown in FIG. 2 and FIG. 4, the outer iron core 241 and the inner iron core 242 are fixedly connected together by the windings 27, which prevent the outer iron core 241 and the inner iron core 242 from separation from each other and thereby fix the fixing rods 246 in the fixing holes 244 respectively. The windings 27 of the present invention are wound in the following manner, although in other embodiments of the invention the windings 27 may be wound onto the hollow rotor 24 by different methods. Referring to FIG. 5, which shows only a portion of the hollow rotor 24 and two windings 27 for the sake of simplicity, the outer surface of the outer iron core 241 is formed with two adjacent outer winding grooves 243A and 243B, and the inner surface of the inner iron core 242 is formed with two adjacent inner winding grooves 245A and 245B. The outer winding groove 243A corresponds to the inner winding groove 245A while the outer winding groove 243B corresponds to the inner winding groove 245B. One end (hereinafter the first end) of the winding 27A is electrically connected to a commutator plate 221. The other end (hereinafter the second end) of the winding 27A is inserted into the front end of the outer winding groove 243A; passes through the outer winding groove 243A; extends out of the rear end of the outer winding groove 243A; is then inserted into the rear end of the inner winding groove 245A; passes through the inner winding groove 245A; extends out of the front end of the inner winding groove 245A; runs diagonally to and is inserted into the outer winding groove 243B; then runs sequentially through the outer winding groove 243B, the rear end of the outer winding groove 243B, the rear end of the inner winding groove 245B, and the inner winding groove 245B; extends out of the front end of the inner winding groove 245B; and is electrically connected to another commutator plate (hereinafter the second commutator plate) 221. The winding 27A wound in the foregoing manner is referred to as one turn of winding 27A. When it is desired to wind another turn or more turns of winding 27 onto the hollow rotor 24, all that needs to be done is to pass diagonally the winding 27A jutting out of the front end of the inner winding groove 245B into the front end of the outer winding groove 243A and then repeat the winding steps described above. The winding 27B is adjacent to the winding 27A and has its second end (equivalent to the second end of the winding 27A) jutting out of the front end of the inner winding groove 245A. Thus, both the first end of the winding 27A and the second end of the winding 27B are electrically connected to the same commutator plate 221. While supplying a current to the first end of the winding 27A, this commutator plate 221 receives the current delivered through the second end of the winding 27B. When the commutator plate 221 subsequently performs reversal of current direction, the aforesaid current directions are reversed, in order for each of the windings 27A and 27B to generate an electromagnetic field corresponding to the existing current direction.

Referring back to FIG. 2 and FIG. 3, the inner stator 25 is mounted in the axial hole 240 of the hollow rotor 24, and the front and rear ends of the inner stator 25 are fixed to the front and rear ends of the housing 20 respectively. The inner stator 25 is spaced from the hollow rotor 24 by a second spacing 24B to enable free rotation of the hollow rotor 24 outside the inner stator 25. In this embodiment, the inner stator 25 includes an inner stator body 250 and a plurality of inner magnets 251. The inner magnets 251 are fixed to the outer wall of the inner stator body 250 along the circumferential direction of the housing 20. Each two adjacent inner magnets 251 are spaced apart and are opposite in polarity. Each inner magnet 251 can be a single magnetic component or composed of a plurality of magnetic components of the same polar direction; the present invention has no limitations in this regard. Two positioning rods 252 are respectively and protrudingly provided at the front and rear ends of the inner stator body 250 and are fixed to the front and rear ends of the housing 20 via bearings 26A and 26B respectively, wherein the bearings 26A and 26B are respectively and pivotally connected to the commutator 22 and the output element 23. Thus, when the hollow rotor 24, the commutator 22, and the output element 23 are rotated, the inner stator 25 will not be driven, and stability of the inner stator 25 is maintained. In this embodiment, the positioning rods 252 are fixed to the front cover 20A and the rear cover 20B respectively. In other embodiments of the present invention, however, the fixing positions and methods of the positioning rods 252 may vary as appropriate. That is to say, the connection between the inner stator 25 and the housing 20 may vary, provided that the inner stator 25 is fixed in the housing 20 and is kept from rotation. In addition, the inner stator body 250 can be adjusted in configuration or even omitted, provided that the inner stator 25 is mounted in the axial hole 240 of the hollow rotor 24, that the front and rear ends of the inner stator 25 are fixed to the front and rear ends of the housing 20 respectively, and that the inner magnets 251 are fixed to the outer periphery of the inner stator 25 along the circumferential direction of the housing 20.

Referring to FIG. 2, once the outer stator 21, the hollow rotor 24, and the inner stator 25 are put together, the inner magnets 251 correspond to the outer magnets 211 respectively. In a preferred embodiment, each pair of corresponding inner magnet 251 and outer magnet 211 have the same polarity. In practice, however, the winding schemes may be modified in such a way that each pair of corresponding inner magnet 251 and outer magnet 211 have opposite polarities to suit the current directions in different sections of the windings 27. As shown in FIG. 2, when the windings 27 receive the currents supplied by the commutator 22 and generate the corresponding electromagnetic fields, the electromagnetic fields repel the magnetic fields generated by the inner stator 25 and the outer stator 21; in consequence, the hollow rotor 24 is rotated and drives the output element 23 simultaneously. The output element 23 drives the transmission element and the load in turn through the output holes 201 such that the rotating force generated by the hollow rotor 24 and featuring both a low rotation speed and a large torque is output to the load. It can be known from the above that the DC motor structure 2 of the present invention is totally different from the conventional DC motors: a conventional DC motor drives a load through the output shaft, which, exemplified by the output shaft 111 in FIG. 1A, is a portion of the motor shaft, whereas the present invention drives a load through the output element 23, which is fixed to the rear end of the hollow rotor 24 by plural fixing rods 246 and has a greater volume than the conventional output shaft to prevent the axis shift problem typical of the conventional DC motors. Furthermore, compared with the conventional DC motors, the DC motor structure 2 of the present invention can generate a greater rotating force at a low rotation speed, so the components of the DC motor structure 2 are subject to less wear and tear; that is to say, the DC motor structure 2 is expected to have a longer service life.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A direct-current (DC) motor structure with a hollow rotor and inner and outer stators, comprising:
a housing provided therein with a receiving space;
an outer stator mounted in the receiving space and comprising a plurality of outer magnets, wherein the outer magnets are fixed to an inner wall of the housing along a circumferential direction of the housing, and each two adjacent said outer magnets are spaced apart and are opposite in polarity;
a commutator provided in the housing at a position adjacent to a front end of the housing, the commutator being pivotally connected to the housing along an axial direction of the housing, the commutator comprising a plurality of commutator plates, each two adjacent said commutator plates being configured to supply a current to a winding and to reverse a direction of the current at a preset frequency so that an electromagnetic field generated by the winding is simultaneously reversed too, wherein the direction is repeatedly reversed at the preset frequency;
an output element provided in the housing at a position adjacent to a rear end of the housing, the output element being pivotally connected to the housing along the axial direction of the housing;
a hollow rotor mounted in the outer stator along the axial direction of the housing, the hollow rotor being spaced from the outer stator by a first spacing, the hollow rotor being wound with a plurality of said windings, each said winding having two ends respectively and electrically connected to two adjacent said commutator plates of the commutator in order to receive the current supplied by the commutator and cause the hollow rotor to generate a corresponding electromagnetic field, the hollow rotor being formed therein with an axial hole extending along an axial direction of the hollow rotor, the hollow rotor having a front end fixed to the commutator and a rear end fixed to the output element such that the commutator and the output element are simultaneously rotatable with the hollow rotor; and
an inner stator mounted in the axial hole of the hollow rotor, the inner stator having a front end fixed to the front end of the housing and a rear end fixed to the rear end of the housing, the inner stator being spaced from the hollow rotor by a second spacing, the inner stator comprising a plurality of inner magnets, wherein the inner magnets are fixed to an outer periphery of the inner stator along the circumferential direction of the housing, each two adjacent said inner magnets are spaced apart and are opposite in polarity, and the inner magnets correspond to the outer magnets respectively.

2. The DC motor structure of claim 1, wherein the rear end of the housing is formed with at least one output hole in communication with the receiving space, and the output element corresponds in position to the output hole.

3. The DC motor structure of claim 2, wherein the hollow rotor is assembled from a plurality of iron cores, and the iron cores are wound with the windings.

4. The DC motor structure of claim 3, wherein the housing is assembled from a housing body, a front cover, and a rear cover; the housing body is tubular; the front cover is mounted to a front end of the housing body; and the rear cover is mounted to a rear end of the housing body and is formed with the output hole.

5. The DC motor structure of claim 4, wherein the commutator comprises a disk in addition to the commutator plates, the disk has a front side provided with the commutator plates, each two adjacent said commutator plates are spaced apart, and the front end of the hollow rotor is fixed to a rear side of the disk.

6. The DC motor structure of claim 5, further comprising a plurality of fixing rods, the fixing rods being fixed to the hollow rotor along a circumferential direction of the hollow rotor, each said fixing rod having a front end fixed to the commutator and a rear end fixed to the output element.

7. The DC motor structure of claim 6, wherein the hollow rotor comprises an outer iron core and an inner iron core, the outer iron core has an inner surface and an outer surface, the outer surface of the outer iron core is provided with a plurality of outer winding grooves extending along an axial direction of the outer iron core so as to receive the windings, the inner iron core has an inner surface and an outer surface, the inner surface of the inner iron core is provided with a plurality of inner winding grooves extending along an axial direction of the inner iron core so as to receive the windings, the outer surface of the inner iron core lies against the inner surface of the outer iron core, and the fixing rods are fixed between the inner iron core and the outer iron core.

8. The DC motor structure of claim 7, wherein the front cover and the rear cover are each provided with a plurality of engaging portions for engaging with the housing body.

9. The DC motor structure of claim 8, wherein each said inner magnet and the corresponding outer magnet are opposite in polarity.

10. The DC motor structure of claim 8, wherein each said inner magnet and the corresponding outer magnet are identical in polarity.

11. The DC motor structure of claim 4, wherein the outer magnets are fixed to an inner wall of the housing body.

12. The DC motor structure of claim 11, wherein the commutator comprises a disk in addition to the commutator plates, the disk has a front side provided with the commutator plates, each two adjacent said commutator plates are spaced apart, and the front end of the hollow rotor is fixed to a rear side of the disk.

13. The DC motor structure of claim 12, further comprising a plurality of fixing rods, the fixing rods being fixed to the hollow rotor along a circumferential direction of the hollow rotor, each said fixing rod having a front end fixed to the commutator and a rear end fixed to the output element.

14. The DC motor structure of claim 13, wherein the hollow rotor comprises an outer iron core and an inner iron core, the outer iron core has an inner surface and an outer surface, the outer surface of the outer iron core is provided with a plurality of outer winding grooves extending along an axial direction of the outer iron core so as to receive the windings, the inner iron core has an inner surface and an outer surface, the inner surface of the inner iron core is provided with a plurality of inner winding grooves extending along an axial direction of the inner iron core so as to receive the windings, the outer surface of the inner iron core lies against the inner surface of the outer iron core, and the fixing rods are fixed between the inner iron core and the outer iron core.

15. The DC motor structure of claim 14, wherein the front cover and the rear cover are each provided with a plurality of engaging portions for engaging with the housing body.

16. The DC motor structure of claim 15, wherein each said inner magnet and the corresponding outer magnet are opposite in polarity.

17. The DC motor structure of claim 15, wherein each said inner magnet and the corresponding outer magnet are identical in polarity.

18. The DC motor structure of claim 4, wherein the outer stator further comprises an outer stator body, the outer stator body is fixed to an inner wall of the housing body and is tubular, and the outer magnets are fixed in the outer stator body.

19. The DC motor structure of claim 4, wherein the inner stator further comprises an inner stator body, and the inner magnets are distributed on an outer side of the inner stator body.

20. The DC motor structure of claim 19, wherein the inner stator body has a front end and a rear end each protrudingly provided with a positioning rod, each said positioning rod is fixed to one of the front end and the rear end of the housing via a bearing, and the commutator and the output element are respectively and pivotally connected to the bearings.
